(19) United States
(12) Patent Application Publication
(10) Pub. No.: US 2003/0104818 A1
(43) Pub. Date: Jun. 5, 2003

(54) Communications handset altitude determination in multi-level environments and methods therefor

(76) Inventor: Michael D. Kotzin, Buffalo Grove, IL (US)

Correspondence Address: MOTOROLA INC, 600 NORTH US HIGHWAY 45, LIBERTYVILLE, IL, 60048-5343, US

(21) Appl. No.: 09/998,476

(22) Filed: Nov. 30, 2001

(51) Int. Cl. H04Q 7/20

(52) U.S. Cl. 455/456; 455/41

(57) ABSTRACT

A method in a mobile wireless communications handset located in a multi-level environment, for example a multi-floor building, including receiving first altitude information, for example the floor number, from an altitude information transmitter when the handset is on a first level, and receiving second altitude information from an altitude information transmitter when the handset is on a second level different than the first level. The different altitude information may be transmitted from different transmitters on corresponding levels, or from a single transmitter, located for example in an elevator.

### FIELD OF THE INVENTIONS

The present inventions relate generally to mobile communications handset location technologies, and more particularly to determining altitude in multi-level environments, for example in high-rise buildings, and methods therefor.

### BACKGROUND OF THE INVENTIONS

Most position determination schemes for mobile wireless communication devices, other than Global Positioning System (GPS) enabled devices, do not determine altitude. GPS and other satellite positioning system enabled communication devices are capable of determining altitude, but this capability is dependent upon adequate reception of satellite signals, which are often obstructed, particularly inside buildings where altitude information may be most desirable.

The various aspects, features and advantages of the present invention will become more fully apparent to those having ordinary skill in the art upon careful consideration of the following Detailed Description of the Invention with the accompanying drawings described below.

### BRIEF DESCRIPTION OF THE DRAWINGS

FIG. 1 is a first exemplary altitude information transmission and reception scheme in a multi-level environment.

FIG. 2 is a second exemplary altitude information transmission and reception scheme in a multi-level environment.

FIG. 3 is a third exemplary altitude information transmission and reception scheme in a multi-level environment.

### DETAILED DESCRIPTION OF THE INVENTIONS

The inventions relate generally to methods in mobile wireless communications handsets located in multi-level environments, for example in multi-level buildings, or in mines, or in mountainous areas, for example at logging sites.

According to the invention, generally, a communications handset receives first level altitude information from an altitude information transmitter when the handset is on a first level of the environment, and the handset receives second level altitude information from an altitude information transmitter when the handset is on a level of the environment. The transmitters may be the same transmitter or different transmitters.

In the present patent specification, the terms “first” and “second” level or floor refer to any two different levels or floors of the environment where the altitude information is transmitted and received. The terms “first” and “second” include literally the first and second floors or levels, but these terms are not to be limited to such a literal interpretation, since the terms “first” and “second” are used herein merely to define and distinguish between any two different floors or levels of the environment having different altitude information.

In multi-level building altitude determination applications, first level altitude information, for example the floor number or level information, is received by the handset when the handset is on the first floor of the building from a first altitude information transmitter on the first floor of the building. Second level altitude information is received by the handset when the handset is on the second floor of the building from a second altitude information transmitter on the second floor of the building.

In some embodiments, each floor of the building, and more generally each level of the environment, includes at least one corresponding level altitude transmitter. In other embodiments, each floor or level includes a plurality of corresponding level altitude transmitters, for example where the floor or level is a relatively large area having multiple access points.

The transmitter may be a Bluetooth transmitter or some other transmitter capable of transmitting floor or level altitude information to communications handsets.

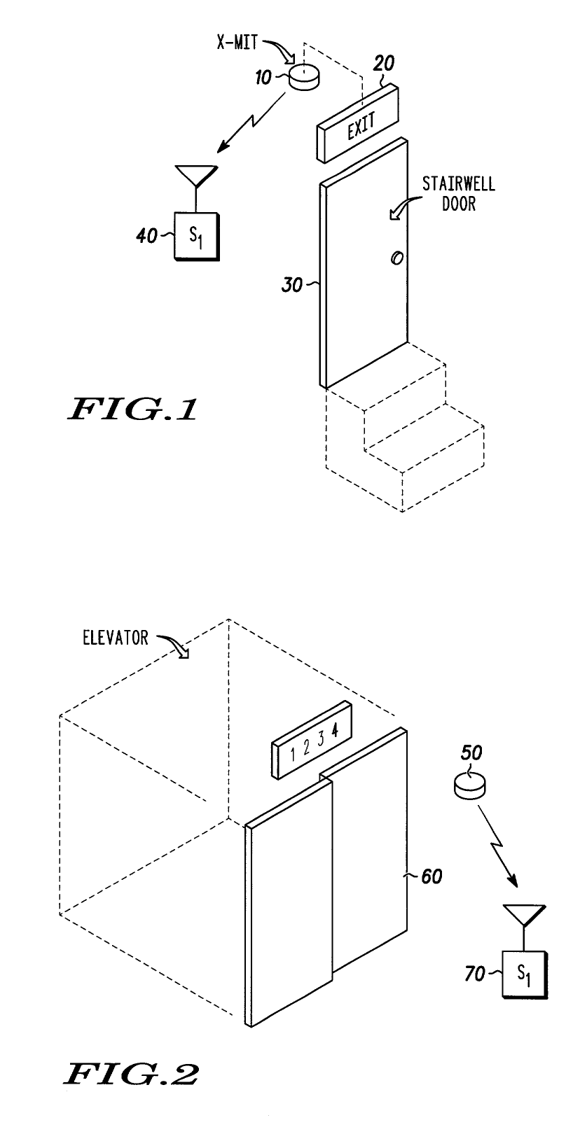

In one embodiment, the transmitter is located at a stairwell door of each floor or level of the building. In buildings having multiple stairwell doors, a transmitter is located at each door, including at any elevator doors. In FIG. 1, for example, the transmitter 10 is at or housed within an “Exit” sign 20 near the stairwell door 30. The location of the transmitter at or within the Exit sign near the stairwell door ensures that communications handsets 40 passing through the door will receive altitude information from the transmitter 10. In this exemplary embodiment, the Exit sign 20 also provides power to the transmitter 10. In this embodiment, there is at least one transmitter on each floor of the building at or near the stairwell doors.

In FIG. 2, the transmitter 50 is located on each building floor near elevator doors 60 where altitude information will be received by communications handsets 70 passing through the elevator doors 60. In this embodiment, the transmitter 50 obtains power from a power source at or near the elevator doors, for example the power source for the elevator indicator or for lighting near the elevator door. In this embodiment, there is at least one transmitter on each floor of the building at or near the elevator doors.

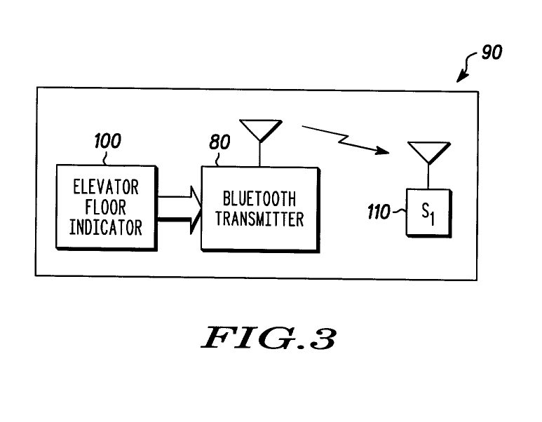

In FIG. 3, a single altitude level information transmitter 80 is located at an elevator carriage 90, for example within or outside the door thereof. In the exemplary embodiment, the transmitter is coupled to and obtains floor level information from a floor level indicator 100 in the elevator carriage, for transmission to a communications handset 110 in the elevator. In this embodiment, only a single transmitter is required.

The altitude level information transmitted from the altitude information transmitter and received by the handset may be building floor or level or other relative altitude level information.

In some embodiments, the communications handset is a satellite positioning system enabled handset, for example a Global Positioning System (GPS) enabled handset. The altitude level information transmitted by the transmitter and received by the GPS enabled communications handset may also include estimated or absolute altitude information provided in a form, for example relative to mean-sea-level, for aiding GPS based position fix determinations.

In some applications, the communications handset transmits altitude information, for example building floor or level, alone or with geographical location fix information of the handset, thus providing relatively precise location information for the handset, for example to a network operator. The geographical location fix may be determined by any known location technology, including GPS based location or terrestrial based location determination schemes.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A method in a mobile wireless communications handset located in a multi-floor building, comprising:
receiving first altitude information from an altitude information transmitter when the handset is on a first floor of the building;
receiving second altitude information from an altitude information transmitter when the handset is on a second floor of the building,
the first floor of the building different than the second floor of the building.

2. The method of claim 1, receiving first altitude information when the handset is on the first floor of the building by receiving first floor level information from a first altitude information transmitter on the first floor of the building, receiving second altitude information when the handset is on the second floor of the building by receiving second floor level information from a second altitude information transmitter on the second floor of the building.

3. The method of claim 2, determining a geographical location fix of the handset, transmitting a location fix of the handset and most recent building floor level information from the handset.

4. The method of claim 1, receiving first altitude information from a first floor Bluetooth transmitter located on the first floor of the building when the handset is on the first floor of the building, receiving second altitude information from a second floor Bluetooth transmitter located on the second floor of the building when the handset is on the second floor of the building.

5. The method of claim 1, receiving first altitude information from at least one of a plurality of first floor transmitters located on the first floor of the building when the handset is on the first floor of the building, receiving second altitude information from at least one of a plurality of second floor transmitters located on the second floor of the building when the handset is on the second floor of the building.

6. The method of claim 1, the handset is a Global Positioning System enabled handset, determining a Global Positioning System based location fix of the handset using altitude information received from the altitude information transmitter on the floor of the building on which the handset is located when determining the location fix.

7. The method of claim 1, receiving first altitude information when the handset is on the first floor of the building by receiving first floor level information from a first altitude information transmitter located at a first floor stairwell door exit sign of the building, receiving second altitude information when the handset is on the second floor of the building by receiving second floor level information from a second altitude information transmitter located at a second floor stairwell door exit sign of the building.

8. The method of claim 1, receiving first altitude information when the handset is on the first floor of the building by receiving first floor level information from a first altitude information transmitter located at a first floor elevator door of the building, receiving second altitude information when the handset is on the second floor of the building by receiving second floor level information from a second altitude information transmitter located at a second floor elevator door of the building.

9. The method of claim 1, receiving first altitude information when the handset is on the first floor of the building by receiving first floor number information from a floor level information transmitter located in an elevator carriage of the building, receiving second altitude information when the handset is on the second floor of the building by receiving second floor number information from the same floor level information transmitter located in the elevator carriage of the building.

10. A method in a mobile wireless communications handset located in a multi-level environment, comprising:
receiving first level altitude information from an altitude information transmitter when the handset is on a first level of the multi-level environment;
receiving second level altitude information from a second altitude information transmitter when the handset is on a second level of the multilevel environment.

11. The method of claim 10, determining a geographical location fix of the handset, transmitting a location fix of the handset and most recent altitude information from the handset.

12. The method of claim 10, receiving first level altitude information from a first level Bluetooth transmitter located on the first level when the handset is on the first level, receiving second level altitude information from a second level Bluetooth transmitter located on the second level when the handset is on the second level.

13. The method of claim 10, receiving first level altitude information from at least one of a plurality of first level transmitters located on the first level when the handset is on the first level, receiving second level altitude information from at least one of a plurality of second level transmitters located on the second level when the handset is on the second level.

14. The method of claim 10, receiving first level altitude information when the handset is on the first level by receiving first level information from a level information transmitter located in an elevator carriage, receiving second altitude information when the handset is on the second level by receiving second level information from that same level information transmitter located in the elevator carriage.

15. A method in a multi-level building, the method comprising:
transmitting first level altitude information for a mobile communications handset from a first level altitude information transmitter on a first level of the building;
transmitting second level altitude information for a mobile communications handset from a second level altitude information transmitter on a second level of the building.

16. The method of claim 15,
transmitting first level altitude information for a mobile communications handset from a plurality of first level altitude information transmitters on the first level of the building;
transmitting second level altitude information for a mobile communications handset from a plurality of second level altitude information transmitters on the second level of the building.

17. The method of claim 15,
transmitting first level altitude information for a mobile communications handset from a first level altitude information Bluetooth transmitter on a first level of the building;
transmitting second level altitude information for a mobile communications handset from a second level altitude information Bluetooth transmitter on a second level of the building.

18. The method of claim 15,
transmitting first level altitude information for a mobile communications handset from a first level altitude information transmitter located at a first level elevator door of the building;
transmitting second level altitude information for a mobile communications handset from a second level altitude information transmitter located at a second level elevator door of the building.

19. The method of claim 15,
transmitting first level altitude information for a mobile communications handset from a first level altitude information transmitter located at a first level stairwell door of the building;
transmitting second level altitude information for a mobile communications handset from a second level altitude information transmitter located at a second level stairwell door of the building.

20. A method in a multi-level building, the method comprising:
transmitting building level information for more than one floor of the building, for reception by a mobile communications handset, from the same level information transmitter on an elevator carriage of the building;
providing floor level information to the single floor level information transmitter from an elevator floor level detector of the elevator carriage.
